(19) United States
(12) Patent Application Publication
(10) Pub. No.: US 2014/0133611 A1
(43) Pub. Date: May 15, 2014

(54) WIRELESS COMMUNICATION APPARATUS AND ONE-PATH STATE DETERMINATION METHOD

(71) Applicants: NTT DOCOMO, INC., Tokyo (JP); FUJITSU LIMITED, Kawasaki-shi (JP)

(72) Inventors: Masatsugu SHIMIZU, Yokohama (JP); Tsuyoshi HASEGAWA, Kawasaki (JP)

(73) Assignees: NTT DOCOMO, INC., Tokyo (JP); FUJITSU LIMITED, Kawasaki-shi (JP)

(21) Appl. No.: 14/055,339

(22) Filed: Oct. 16, 2013

(30) Foreign Application Priority Data
Nov. 13, 2012 (JP) 2012-249533

(51) Int. Cl. H04L 25/03

(52) U.S. Cl. CPC H04L 25/03057
USPC 375/348

(57) ABSTRACT

A wireless communication apparatus includes a wireless unit configured to receive a radio signal; and a signal processing unit configured to detect a phase shift between a detection timing of a path relevant to the received signal at the wireless unit and a path timing of the received signal, to calculate interference power by a first path having a maximum power value based on the phase shift, to calculate power of one or more second paths other than the first path based on the interference power, and to determine whether the received signal is received in a one-path state or a multi-path state based on the power value of the first path and the power values of the one or more second paths.

### CROSS-REFERENCE TO RELATED APPLICATIONS

This application is based upon and claims the benefit of priority of the prior Japanese Priority Application No. 2012-249533 filed on Nov. 13, 2012, the entire contents of which are hereby incorporated by reference.

### FIELD

The disclosures herein generally relate to a wireless communication system.

### BACKGROUND

In recent years, wireless communication has been developed to be further faster, and commercial services of new systems such as LTE (Long Term Evolution) have been started.

Also, conventional wireless communication systems have been expanded continuously. For example, HSPA+ (High Speed Packet Access Plus) specifies a maximum transmission speed of 42 Mbps for downstream at Category 20.

Also, in wireless communication systems, signal processing called equalization using an equalizer is executed for reducing distortion generated through a transmission line.

Equalization will be described below.

A portable terminal may receive a radio signal from multiple paths (multi-path signal) due to reflection caused by a mountain, a building, and the like. Depending on such paths, arrival times of the signal through the paths at the portable terminal may differ from each other. Also, depending on reflection and the like, amplitudes at reception may differ from each other. These differences of arrival times and amplitudes at reception generate distortion on the received signal.

If distortion is generated on a received signal, an intersymbol interference is generated in which a transmitting pulse and an adjacent pulse are overlapped, which makes it difficult to correctly distinguish the transmitting pulse at reception.

To remove such an intersymbol interference and to compensate for degradation of transmission quality, a filter called an equalizer is used. For example, a control apparatus for an equalizer is known that provides a one-path state determination method, which determines that a signal is received in a one-path state if the ratio of power between the power value of a maximum-power path and a total of power values of the other paths exceeds a threshold value. If the received signal is determined being in a one-path state, other paths are estimated as noise to be excluded from a demodulation process, which improves characteristics of the received signal (see, for example, Patent Document 1).

### RELATED-ART DOCUMENTS

### Patent Documents

[Patent Document 1] Japanese Patent No. 4801775

FIG. 1 illustrates an example of a power waveform of a filter response in a path search process using a matched filter in a one-path environment. In FIG. 1, the horizontal axis represents relative sampling timings having the detection timing of a maximum-power path at the center, and the vertical axis represents power at reception. In FIG. 1, a power waveform of a filter response with the detected paths is illustrated. The waveform in FIG. 1 is obtained with a portable terminal having HSPA+ applied, with quadruple oversampling. Quadruple oversampling is quadruple-precision sampling with respect to an HSPA+ chip rate.

In FIG. 1, the power waveform has a mountain-shaped profile having a path with maximum power (maximum-power path) at the center.

In FIG. 1, paths may be detected at sampling points designated with white circles. Although it is ideal that paths are not detected at sampling points at ±1, 2, and 3 in a one-path environment, paths seem to exist at these points because interference power values are detected at the sampling points at ±1, 2, and 3 due to the filter response of the sampling point at 0. Therefore, when determining whether a signal is received in a one-path state, it may be determined being in a multi-path state even if it is received in a one-path environment.

Conversely, if there is a path at the sampling point at 3, the power value of the sample at 3 includes interference power due to the impulse response of the peak path. Therefore, the measured power is seemingly greater than actual power. To improve accuracy of one-path state determination, it is preferable to take interference power due to the impulse response of the peak path into consideration.

Also, frequency deviation exists between a base station and a portable terminal. Due to accumulated residuals of the frequency deviation, path detection timing may be shifted from an actual timing of a received signal in units finer than detection precision of path searching.

FIG. 2 illustrates an example of power waveforms with and without a phase shift where the power waveforms are filter responses with paths in a path search process using a matched filter in a one-path environment, and the phase shift is a shift between an actual path timing and a path detection timing. In FIG. 2, the horizontal axis represents relative sampling timing having the detection timing of a maximum-power path at the center, and the vertical axis represents power. The solid line designates the waveform without a phase shift of timings, and the dashed line designates the waveform with a phase shift of the timings. In the example in FIG. 2, the phase shift of the timings is ½ of the sampling interval. As illustrated in FIG. 2, the power values at the same sampling timing have interference power smaller or greater than each other with the shift between the actual path timing and the path detection timing. In the example in FIG. 2, at plus timings, the samples with the phase shift have smaller interference power than the samples without the phase shift. Conversely, at minus timings, the samples with the phase shift have greater interference power than the samples without the phase shift.

To improve accuracy of one-path state determination, it is preferable to take a phase shift of detection timing in path searching into consideration because the phase shift of detection timing in path searching may increase or decrease interference power.

As described above, to improve accuracy of one-path state determination, it is preferable to take interference power due to the impulse response of the peak path (maximum-power path) and a phase shift of detection timing in path searching into consideration.

For example, if it is determined as multi-path even if it is a one-path environment, noise may not be removed sufficiently and a demodulation process may be executed with much noise. Conversely, if it is determined as one-path even if it is a multi-path environment, a signal component may be erroneously removed as noise in the demodulation process. In either case, characteristics of a received signal are degraded.

### SUMMARY

According to an embodiment of the present invention, a wireless communication apparatus includes: a wireless unit configured to receive a radio signal; and a signal processing unit configured to detect a phase shift between a detection timing of a path relevant to the received signal at the wireless unit and a path timing of the received signal, to calculate interference power by a first path having a maximum power value based on the phase shift, to calculate power of one or more second paths other than the first path based on the interference power, and to determine whether the received signal is received in a one-path state or a multi-path state based on the power value of the first path and the power values of the one or more second paths.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a schematic view illustrating a first example of a filter response around a peak path;

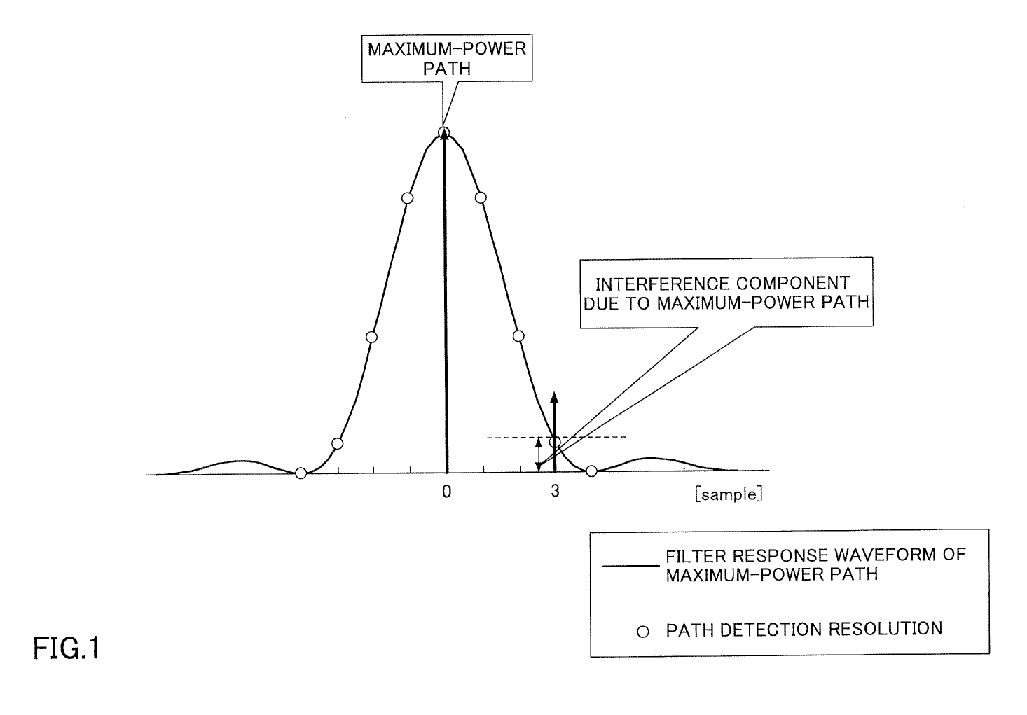

FIG. 2 is a schematic view illustrating a second example of a filter response around a peak path;

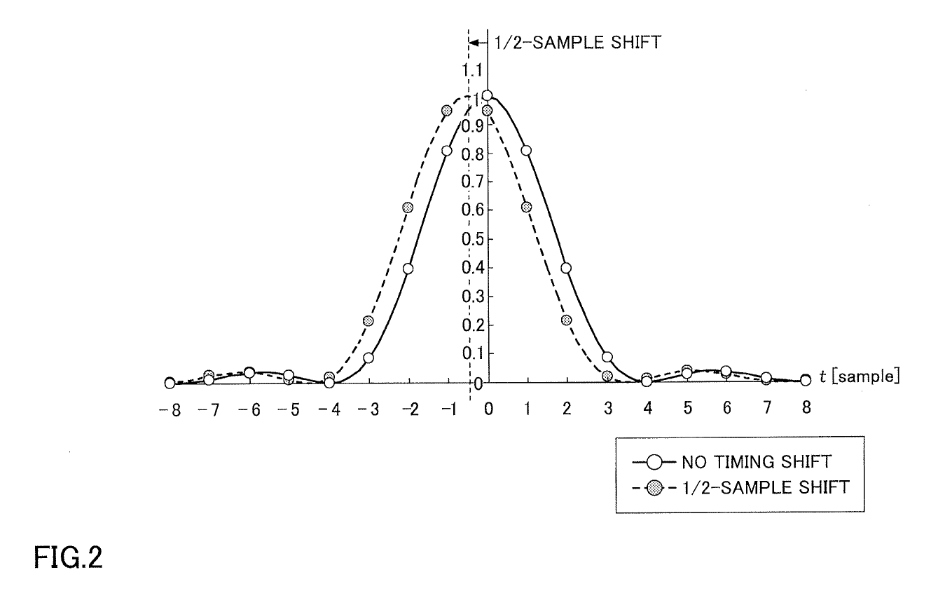

FIG. 3 is a schematic view illustrating a wireless communication apparatus according to an embodiment;

FIG. 4 is a functional block diagram of a wireless communication apparatus according to an embodiment;

FIG. 5 is another functional block diagram of a wireless communication apparatus according to an embodiment;

FIG. 6 is a schematic view illustrating an interference power ratio selection table according to an embodiment;

FIG. 7 is a flowchart illustrating an example of operation of a wireless communication apparatus according to an embodiment; and

FIG. 8 is another flowchart illustrating an example of operation of a wireless communication apparatus according to an embodiment.

### DESCRIPTION OF EMBODIMENTS

In the following, embodiments will be described with reference to the drawings. Here, elements that have the same function are assigned with the same numerical code throughout the drawings, and their explanation may not be repeated. According to an embodiment of the present invention, accuracy can be improved for determining whether a radio signal is received in a one-path state or a multi-path state.

<Wireless Communication Apparatus 100>

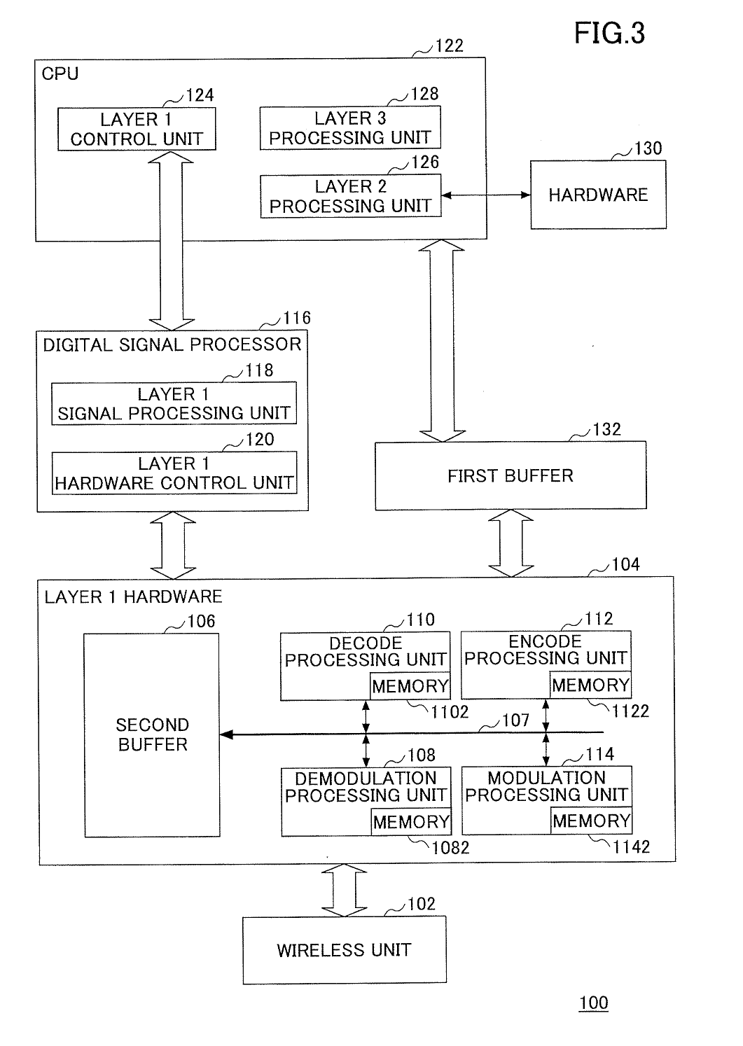

FIG. 3 is a schematic view illustrating a wireless communication apparatus 100 according to an embodiment. FIG. 3 mainly illustrates a hardware configuration of the wireless communication apparatus 100.

The wireless communication apparatus 100 includes a wireless unit 102, a layer-1 hardware 104, a digital signal processor (DSP) 116, a first buffer 132, a central processing unit (CPU) 122, and hardware 130.

The wireless unit 102 converts a high-frequency signal from an antenna to a baseband signal. The wireless unit 102 inputs the baseband signal into the layer-1 hardware 104. Also, the wireless unit 102 converts a baseband signal from the layer-1 hardware 104 into a high-frequency signal. The wireless unit 102 transmits the high-frequency signal from the antenna.

The layer-1 hardware 104 is connected with the wireless unit 102. The layer-1 hardware 104 executes a layer 1 process. For example, the layer-1 hardware 104 may be implemented with a signal processing circuit.

The layer-1 hardware 104 includes a second buffer 106, a demodulation processing unit 108, a decode processing unit 110, an encode processing unit 112, and a modulation processing unit 114. The second buffer 106, the demodulation processing unit 108, the decode processing unit 110, the encode processing unit 112, and the modulation processing unit 114 are connected with each other by a bus 107. The demodulation processing unit 108 includes a local memory 1082, the decode processing unit 110 includes a local memory 1102, the encode processing unit 112 includes a local memory 1122, and the modulation processing unit 114 includes a local memory 1142.

The second buffer 106 temporarily stores data exchanged between the demodulation processing unit 108 and the decode processing unit 110, or between the encode processing unit 112 and the modulation processing unit 114. Alternatively, instead of using the second buffer 106, the data may be transferred to the local memory in each of the blocks by DMA (Direct Memory Access).

The demodulation processing unit 108 demodulates a symbol having multilevel modulation applied, to recover the data that has spread.

The decode processing unit 110 decodes a received signal.

The encode processing unit 112 encodes a transmitting signal.

The modulation processing unit 114 modulates the transmitting signal.

The DSP 116 is connected with the layer-1 hardware 104. The DSP 116 functions as the layer-1 signal processing unit 118 and the layer-1 hardware control unit 120. For example, the DSP 116 may be implemented with a signal processing circuit.

The layer-1 signal processing unit 118 executes a layer 1 process. For example, the layer-signal processing unit 118 may execute path searching for detecting paths, and determine whether it is a one-path environment. Also, the layer-1 signal processing unit 118 may execute a part of the process executed by the layer-1 hardware 104.

The layer-1 hardware control unit 120 controls the layer-1 hardware 104. The layer-1 hardware control unit 120 may set operation parameters for the units included in the layer-1 hardware 104.

The CPU 122 is connected with the DSP 116. The CPU 122 functions as the layer-1 control unit 124, the layer-2 processing unit 126, and the layer-3 processing unit 128.

The layer-1 control unit 124 controls the layer-1 signal processing unit 118 when the DSP 116 functions as the layer-1 signal processing unit 118.

The layer-2 processing unit 126 executes a layer 2 process. For example, the layer-2 processing unit 126 executes the layer 2 process on received data processed by the layer-1 hardware 104. The CPU 122 functions as the layer-2 processing unit 126 based on software built into the CPU 122. The layer-2 processing unit 126 may have the hardware 130 execute a heavy-load part of the process. For example, the layer-2 processing unit 126 may have the hardware 130 execute encryption.

The layer-3 processing unit 128 executes a layer 3 process. For example, the CPU 122 functions as the layer-3 processing unit 128 based on software built into the CPU 122.

The first buffer 132 is connected with the layer-1 hardware 104 and the CPU 122. The first buffer 132 temporarily stores received data when the received data processed by the layer-1 hardware 104 is transferred to the CPU 122.

The wireless communication apparatus 100 may include multiple CPUs and multiple DSPs.

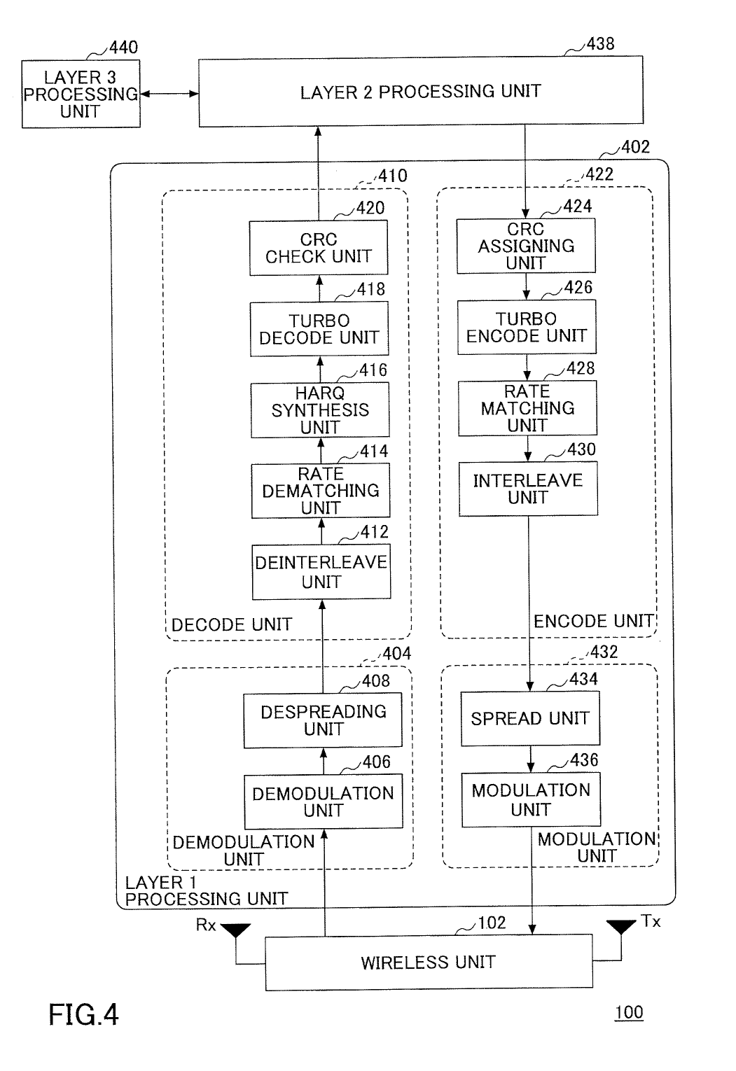

FIG. 4 is a functional block diagram of the wireless communication apparatus 100 according to the present embodiment.

The wireless communication apparatus 100 includes a wireless unit 102, a layer-1 processing unit 402, a layer-2 processing unit 438, and a layer-3 processing unit 440.

The layer-1 processing unit 402 is connected with the wireless unit 102. The layer-1 processing unit 402 includes a demodulation unit 404, a decode unit 410, an encode unit 422, and a modulation unit 432.

The demodulation unit 404 is connected with the wireless unit 102. The demodulation unit 404 includes a demodulation unit 406 and a despreading unit 408. Functions of the demodulation unit 404 are executed by the demodulation processing unit 108.

The demodulation unit 406 is connected with the wireless unit 102. The demodulation unit 406 demodulates a symbol having multilevel modulation applied that is included in the baseband signal from the wireless unit 102. Multilevel modulation may be executed by a modulation method such as QPSK, 16-QAM, 64-QAM, or the like. The demodulation unit 406 inputs the demodulated symbol into the despreading unit 408.

The despreading unit 408 is connected with the demodulation unit 406. The despreading unit 408 applies despreading to spread data to recover the original data. The despreading unit 408 inputs the despreaded data into a deinterleave unit 412.

The decode unit 410 is connected with the demodulation unit 404. The decode unit 410 includes the deinterleave unit 412, a rate matching unit 414, a HARQ synthesis unit 416, a turbo decode unit 418, and a CRC check unit 420. Functions of the decode unit 410 are executed by the decode processing unit 110.

The deinterleave unit 412 is connected with the despreading unit 408. The deinterleave unit 412 recovers the original data from the interleaved data from the despreading unit 408 by applying deinterleaving. The deinterleave unit 412 inputs the deinterleaved data into the rate dematching unit 414.

The rate dematching unit 414 is connected with the deinterleave unit 412. The rate dematching unit 414 recovers the original data that have been extended or shortened in accordance with assigned physical channel resource by applying rate dematching to the data from the deinterleave unit 412. The rate dematching unit 414 inputs rate-dematched data into the HARQ synthesis unit 416.

The HARQ synthesis unit 416 is connected with the rate dematching unit 414. The HARQ synthesis unit 416 synthesizes data to be resent by executing a HARQ resending process. For example, the HARQ synthesis unit 416 holds packet data that has an error detected, and synthesizes it with resent packet data. The HARQ synthesis unit 416 inputs synthesized resent data into the turbo decode unit 418.

The turbo decode unit 418 is connected with the HARQ synthesis unit 416. The turbo decode unit 418 decodes turbo-encoded data. The turbo decode unit 418 inputs decoded data into the CRC check unit 420.

The CRC check unit 420 is connected with the turbo decode unit 418. The CRC check unit 420 determines whether the decoded data from the turbo decode unit 418 is correct. The CRC check unit 420 inputs the determination result on the correctness of the data into the layer-2 processing unit 438.

The encode unit 422 is connected with the layer-2 processing unit 438. The encode unit 422 includes a CRC assigning unit 424, a turbo encode unit 426, a rate matching unit 428, and an interleave unit 430. Functions of the encode unit 422 are executed by the encode processing unit 112.

The CRC assigning unit 424 is connected with the layer-2 processing unit 438. The CRC assigning unit 424 calculates a CRC based on transmitted data from the layer-2 processing unit 438, and attaches the CRC to the data. The CRC assigning unit 424 inputs the transmitted data having the CRC attached into the turbo encode unit 426.

The turbo encode unit 426 is connected with the CRC assigning unit 424. The turbo encode unit 426 encodes the data from the CRC assigning unit 424. The turbo encode unit 426 inputs the encoded data into the rate matching unit 428.

The rate matching unit 428 is connected with the turbo encode unit 426. The rate matching unit 428 extends or shortens data from the turbo encode unit 426 in accordance with assigned physical channel resource. The rate matching unit 428 inputs rate-matched data into the interleave unit 430.

The interleave unit 430 is connected with the rate matching unit 428. The interleave unit 430 interleaves data from the rate matching unit 428.

The interleave unit 430 inputs the interleaved data into a spread unit 434.

The modulation unit 432 is connected with the encode unit 422. The modulation unit 432 includes the spread unit 434 and a modulation unit 436. Functions of the modulation unit 432 are executed by the modulation processing unit 114.

The spread unit 434 is connected with the interleave unit 430. The spread unit 434 spreads the data from the interleave unit 430. The spread unit 434 inputs the spread data into the modulation unit 436.

The modulation unit 436 is connected with the spread unit 434. The modulation unit 436 modulates the data from the spread unit 434. For example, the modulation unit 436 executes modulation by a modulation method such as QPSK, 16-QAM, 64-QAM, or the like. The modulation unit 436 inputs the modulated signal into the wireless unit 102.

The layer-2 processing unit 438 is connected with the layer-1 processing unit 402. The layer-2 processing unit 438 includes sublayers for MAC (Medium Access Control), PDCP (Packet Data Convergence Protocol), RLC (Radio Link Control), and the like. Functions of the layer-2 processing unit 438 are executed by the CPU 122. The layer-2 processing unit 438 separates or unites data in accordance with formats of the sublayers.

The layer-3 processing unit 440 is connected with the layer-2 processing unit 438. The layer-3 processing unit 440 controls a call connection, a handover, and the like in the wireless communication apparatus 100.

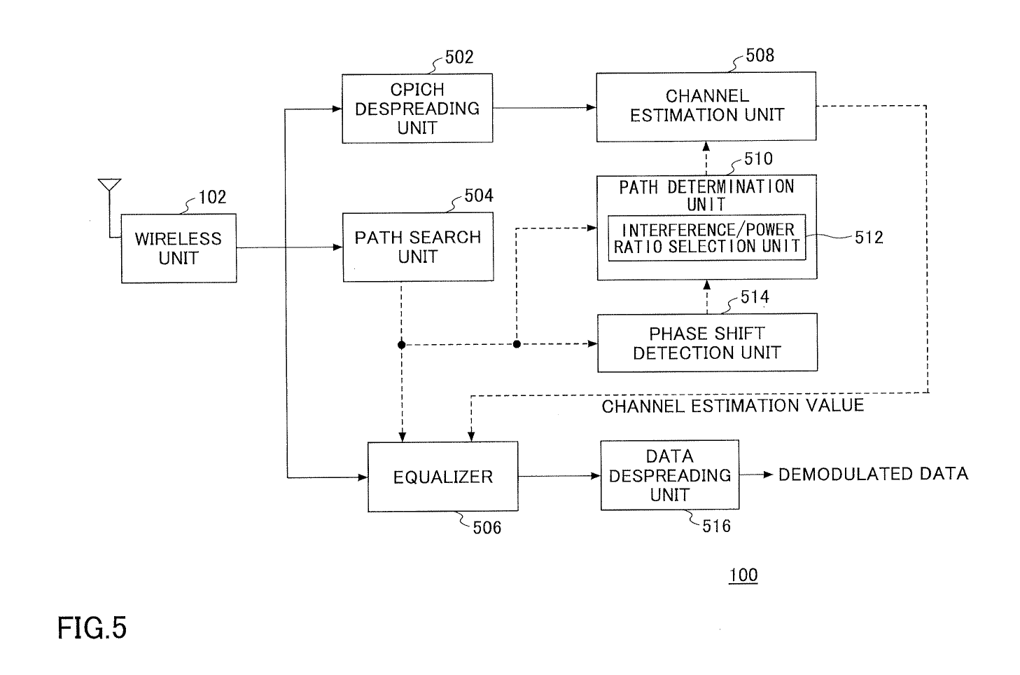

FIG. 5 is another functional block diagram of the wireless communication apparatus 100 according to the present embodiment. FIG. 5 mainly illustrates a part related to determining whether it is a one-path environment based on the result of path searching.

The wireless communication apparatus 100 includes a wireless unit 102, a CPICH (Common Pilot Channel) despreading unit 502, a path search unit 504, an equalizer 506, a channel estimation unit 508, a path determination unit 510, a phase shift detection unit 514, and a data despreading unit 516.

The CPICH despreading unit 502 is connected with the wireless unit 102. The CPICH despreading unit 502 despreads a CPICH included in data received by the wireless unit 102. Functions of the CPICH despreading unit 502 are executed by the demodulation processing unit 108. The CPICH despreading unit 502 inputs the despreaded CPICH into the channel estimation unit 508.

The path search unit 504 is connected with the wireless unit 102. The path search unit 504 detects path timings based on a signal received by the wireless unit 102. Functions of the path search unit 504 are executed by the demodulation processing unit 108. For example, the path search unit 504 measures a delay profile, then detects a path that has great correlation power. The path search unit 504 detects one or more paths. The path search unit 504 inputs timing information (called “path timing information”, hereafter) of the detected paths into the path determination unit 510, the equalizer 506, and the phase shift detection unit 514. Moreover, the path search unit 504 inputs a timing correlation value of a detected path (called “path timing correlation value”, hereafter) and a timing correlation value of a path adjacent to the detected path (called “adjacent timing correlation value”, hereafter) into the phase shift detection unit 514. Moreover, the path search unit 504 inputs power values of the detected paths into the path determination unit 510.

The phase shift detection unit 514 is connected with the path search unit 504. The phase shift detection unit 514 detects a phase shift based on the path timing information, the path timing correlation values, and the adjacent timing correlation values from the path search unit 504. Functions of the phase shift detection unit 514 are executed by the DSP 116. For example, the DSP 116 functions as the phase shift detection unit 514 based on software built into the DSP 116.

The phase shift detection unit 514 receives the path timing information, the path timing correlation values, and the adjacent timing correlation values as input from the path search unit 504. The phase shift detection unit 514 determines the phase is shifted towards a greater adjacent timing correlation value. Also, the phase shift detection unit 514 determines whether the difference between a path timing correlation value and a greater adjacent timing correlation value or the ratio (path timing correlation value/adjacent timing correlation value) is greater than a predetermined threshold value. If the difference between the path timing correlation value and the greater adjacent timing correlation value or the ratio (path timing correlation value/adjacent timing correlation value) is greater than the predetermined threshold value, it is preferable to have the phase shift detection unit 514 determine that there is no phase shift.

If the difference between the path timing correlation value and the adjacent timing correlation value or the ratio is less than the predetermined threshold value, it is preferable to have the phase shift detection unit 514 determine that there is a phase shift.

Here, it is preferable to determine the magnitude of a phase shift by providing multiple threshold values depending on expected magnitude of phase shift and determining a range of the threshold values where the difference between the path timing correlation value and the adjacent timing correlation value or the ratio is contained.

The phase shift detection unit 514 indicates the magnitude and direction of a phase shift to the path determination unit 510.

The path determination unit 510 is connected with the path search unit 504 and the phase shift detection unit 514. Functions of the path determination unit 510 are executed by the DSP 116. For example, the DSP 116 functions as the path determination unit 510 based on software built into the DSP 116.

The path determination unit 510 includes an interference power ratio selection unit 512.

The path determination unit 510 sets an interference power ratio used when removing interference power based on phase shift information from the phase shift detection unit 514. For example, a phase shift may be represented by a sampling timing. For example, an interference power ratio is provided for each sample. An interference power ratio may be a ratio of a power value to be determined as interference to a power value of a peak path. Therefore, by multiplying a power value of the peak path by an interference power ratio corresponding to a sample, a power value to be determined as interference for the sample is obtained.

The path determination unit 510 obtains a relative timing difference ΔTn between the peak path timing and an n-th (n is an integer, n>0) path timing based on the path timing information from the path search unit 504.

The interference power ratio selection unit 512 selects an interference power ratio for the n-th path based on the phase shift from the phase shift detection unit 514 and relative timing difference.

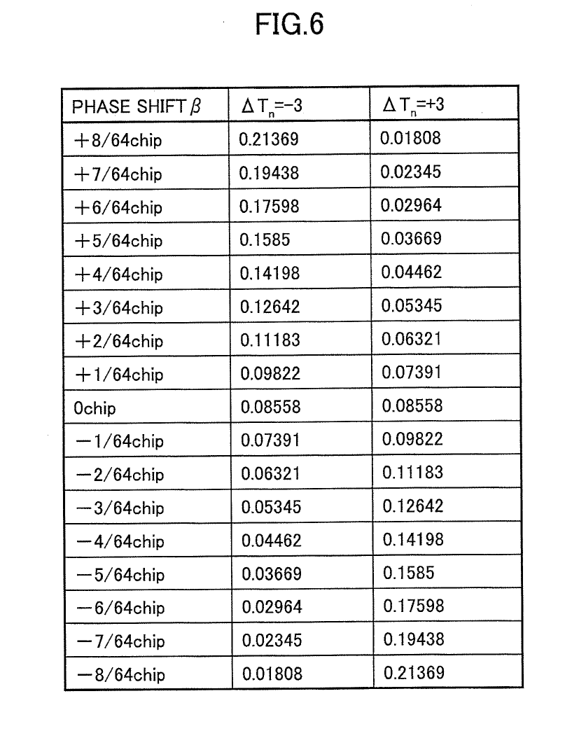

FIG. 6 is a schematic view illustrating an interference power ratio selection table that represents a relationship between a phase shift β, a relative timing difference ΔTn, and an interference power ratio according to the present embodiment.

The table illustrated in FIG. 6 is obtained based on a property of an HSPA+ received signal that has a raised cosine waveform with a band width of 3.84 MHz and a roll-off ratio of 0.22. Specifically, the phase of the raised cosine waveform is shifted to obtain a filter response waveform, from which ratios of the power value of the peak path to the power values of samples at ±3 sampling timings away from the peak path, respectively, are calculated to obtain ratios in the table.

In FIG. 6, phase shifts from − 8/64 chip to + 8/64 chip with an interval of 1/64 chip are associated with interference power ratios that are obtained at ±3 sampling timings away from the peak path. The table illustrated in FIG. 6 is an example. Alternatively, more interference power ratios for more sampling timings may be provided, and the interval of phase shifts may be changed. Also, interference power ratios may be calculated by an algorithm for calculating interference power ratios.

The path determination unit 510 sums up the power values of the paths except for the peak path based on interference power ratios of the paths selected by the interference power ratio selection unit 512. In the following, the total power value of the paths except for the peak path will be referred to as the “total power value”. For example, the path determination unit 510 calculates a threshold value used when removing the interference power of the n-th path (called hereafter “the n-th interference power threshold value”) by multiplying the power value of the peak path by the interference power ratio corresponding to the n-th path from the peak path. The path determination unit 510 subtracts the n-th interference power threshold value from the power value of the n-th path. In the following, a value obtained by subtracting the n-th interference power threshold value from the power value of the n-th path will be called the “n-th interference-deducted power”. If the n-th interference-deducted power is a positive value, the path determination unit 510 adds the n-th interference-deducted power to the total power value.

The path determination unit 510 obtains interference-deducted power for all paths detected by the path search unit 504, and adds positive values of them to the total power value. The path determination unit 510 may obtain interference-deducted power for a part of the paths detected by the path search unit 504, and add each of them to the total power value if it is a positive value.

The path determination unit 510 obtains the ratio of the power value of the peak path to the total power value.

The path determination unit 510 determines that it is one-path if the ratio of the power value of the peak path to the total power value is greater than a threshold value for determining as one-path. The path determination unit 510 determines that it is multi-path if the ratio of the power value of the peak path to the total power value is less than a threshold value for determining as one-path.

The path determination unit 510 inputs the determination result about the paths into the channel estimation unit 508.

The channel estimation unit 508 is connected with the CPICH despreading unit 502 and the path determination unit 510. Functions of the channel estimation unit 508 are executed by the DSP 116. For example, the DSP 116 functions as the channel estimation unit 508 based on software built into the DSP 116.

The channel estimation unit 508 executes channel estimation based on the despreaded CPICH from the CPICH despreading unit 502 and the determination result about the paths from the path determination unit 510. For example, if the determination result indicates that it is one-path, the channel estimation unit 508 may determine that paths except for the maximum-power path are noise. In this case, the channel estimation unit 508 may set the channel estimation value to zero for the paths except for the maximum-power path, not to use them in the demodulation process. Also, for example, if the determination result indicates that it is multi-path, it may execute the channel estimation with the detected paths. The channel estimation unit 508 inputs the channel estimation values into the equalizer 506.

The equalizer 506 is connected with the wireless unit 102, the path search unit 504, and the channel estimation unit 508. Functions of the equalizer 506 are executed by the DSP 116. For example, the DSP 116 functions as the equalizer 506 based on software built into the DSP 116.

The equalizer 506 calculates tap coefficients for an FIR filter based on the received signal from the wireless unit 102 and the channel estimation values from the channel estimation unit 508. The equalizer 506 executes an equalization process by filtering the received signal with the calculated FIR filter using the tap coefficients. The equalizer 506 inputs the received signal having the equalization process applied into the data despreading unit 516.

The data despreading unit 516 is connected with the equalizer 506. Functions of the data despreading unit 516 are executed by the demodulation processing unit 108. The data despreading unit 516 despreads the signal from the equalizer 506, and outputs the demodulated data.

<Operation of Wireless Communication Apparatus 100>

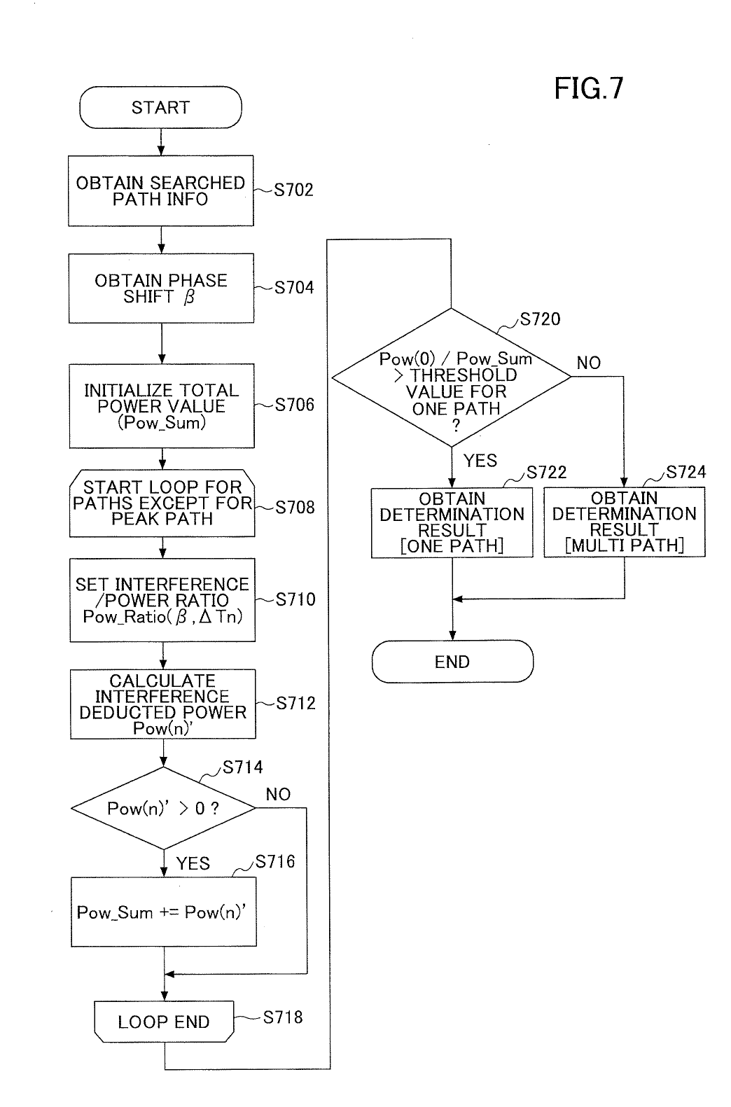

FIG. 7 is a flowchart illustrating an example of operation of a wireless communication apparatus 100 according to the present embodiment.

FIG. 7 mainly illustrates the process executed by the path determination unit 510.

At Step S702, the path determination unit 510 obtains path search information from the path search unit 504. The path search information includes path timing information and power values of the detected paths. The path search information may include the number of detected paths.

At Step S704, the path determination unit 510 obtains a phase shift 3 from the phase shift detection unit 514.

At Step S706, the path determination unit 510 initializes the total power value Pow_Sum.

At Step S708, the path determination unit 510 initializes a loop so that Steps S710-S716 are repeatedly executed for paths except for the peak path.

At Step S710, the interference power ratio selection unit 512 sets up an interference power ratio Pow_Ratio(α, ΔTn) for a path.

At Step S712, the path determination unit 510 calculates interference-deducted power Pow(n)′ by subtracting the interference power threshold value Pow(0)×Pow_Ratio(β, ΔTn) corresponding to the path from the power value Pow(n) of the path.

At Step S714, the path determination unit 510 determines whether the interference-deducted power Pow(n)′ is greater than zero.

At Step S716, if the interference-deducted power Pow(n)′ is greater than zero, the path determination unit 510 adds the total power value to the interference-deducted power Pow(n)′, and sets the added value as a new total power value Pow_Sum.

After the calculation at Step S716, or if the interference-deducted power Pow(n)′ is below zero at Step S714, and if all paths except for the peak path have been processed, then the operation transitions to Step 720, otherwise, transitions to Step S710.

At Step S720, the path determination unit 510 determines whether the ratio Pow(0)/Pow_Sum of the power value of the peak path Pow(0) to the total power value Pow_Sum is greater than the threshold value for determining one-path.

At Step S720, if Pow(0)/Pow_Sum is greater than the threshold value for determining one-path, the path determination unit 510 determines that it is one-path.

At Step S722, if Pow(0)/Pow_Sum is less than the threshold value for determining one-path, the path determination unit 510 determines that it is multi-path.

With the wireless communication apparatus 100 according to the present embodiment, when determining paths relevant to the received signal, interference power is identified in power values of the paths except for the peak path (interference power threshold values) that is induced by an impulse response of the peak path. The wireless communication apparatus 100 determines whether paths relevant to the received signal include one path or multiple paths based on the total value that sums up power values greater than the interference power threshold values.

Moreover, based on a phase shift between path detection timing and the received signal timing, it changes the interference power threshold value. By changing the interference power threshold value based on the phase shift between the path detection timing and the received signal timing, it can cope with change of the interference power threshold value due to the phase shift, which improves accuracy for determining whether paths relevant to the received signal include one-path or multi-path.

### Modified Example

In a modified example of the wireless communication apparatus 100, the process for obtaining an interference power threshold value is omitted for paths detected at timings sufficiently separated from the peak path.

Interference power threshold values at timings sufficiently separated from the peak path are supposed to be small. Therefore, if calculation of the interference power threshold values is omitted, an influence on the total power value is supposed to be small.

The wireless communication apparatus 100 according to the modified example is substantially the same as the one illustrated in FIGS. 3-5.

The path determination unit 510 may be set with paths beforehand whose interference power threshold values are to be obtained. Specifically, the path determination unit 510 may be set with a range of samples, for example, samples at ±3 sampling timings, or the like. The path determination unit 510 determines whether a path is included in the range for obtaining the interference power threshold values for paths except for the peak path. If a path is included in the range for obtaining the interference power threshold values, the path determination unit 510 calculates the interference power threshold value of the path. If a path is not included in the range for obtaining the interference power threshold values, the path determination unit 510 does not calculate the interference power threshold value. If not calculating the interference power threshold value, the path determination unit 510 may set zero to the interference power threshold value of the path.

<Operation of Wireless Communication Apparatus 100>

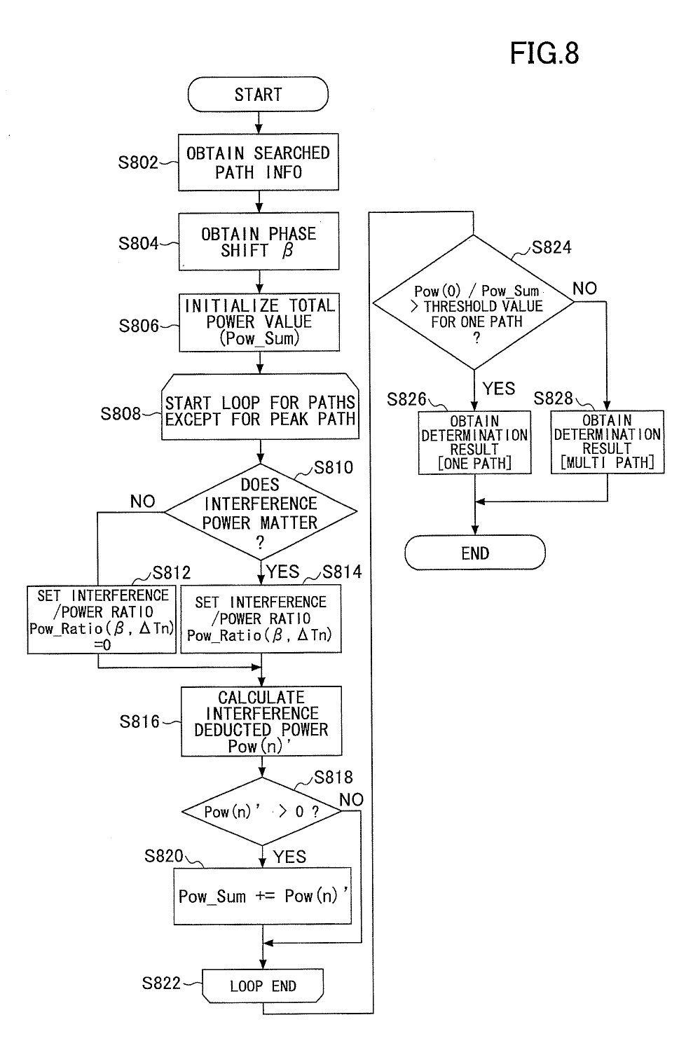

FIG. 8 is another flowchart illustrating an example of operation of the wireless communication apparatus 100 according to the modified example.

FIG. 8 mainly illustrates the process executed by the path determination unit 510.

Steps S802-S808 are substantially the same as Steps S702-S708 in FIG. 7.

At Step S810, the path determination unit 510 determines whether a path is one of the paths whose interference power needs to be obtained. For example, the path determination unit 510 determines whether a path is included in the range for obtaining the interference power threshold values for paths except for the peak path.

At Step S812, if the path is determined to be a path whose interference power does not need to be obtained at Step S810, the interference power ratio selection unit 512 sets zero to an interference power ratio Pow_Ratio(β, ΔTn).

At Step S814, if the path is determined to be a path whose interference power needs to be obtained at Step S810, the interference power ratio selection unit 512 sets the interference power ratio Pow_Ratio(β, ΔTn).

At Step S816, the path determination unit 510 calculates interference-deducted power Pow(n)′ by subtracting an interference power threshold value Pow(0)×Pow_Ratio(β, ΔTn) corresponding to the path from the power value Pow(n) of the path.

Steps S818-S828 are substantially the same as Steps S714-S724 in FIG. 7.

With the wireless communication apparatus 100 according to the present embodiment, when determining paths relevant to the received signal, interference power is identified in power values of the paths except for the peak path (interference power threshold values) that is induced by an impulse response of the peak path. The wireless communication apparatus 100 determines whether paths relevant to the received signal include one path or multiple paths based on the total value that sums up power values greater than the interference power threshold values.

Moreover, based on a phase shift between path detection timing and the received signal timing, it changes the interference power threshold value. By changing the interference power threshold value based on the phase shift between the path detection timing and the received signal timing, it can cope with change of the interference power threshold value due to the phase shift, which improves accuracy for determining whether paths relevant to the received signal include one-path or multi-path.

Moreover, by setting a range for paths whose interference power threshold values are calculated and setting the interference power threshold values of the paths excluded from the range to zero, the amount of information included in the interference power ratio selection table can be reduced. Moreover, the amount of calculation for calculating interference power threshold values can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus comprising:
a wireless unit configured to receive a radio signal,
a signal processing unit configured
to detect a phase shift between a detection timing of a path relevant to the received signal at the wireless unit and a path timing of the received signal,
to calculate interference power by a first path having a maximum power value based on the phase shift,
to calculate power of one or more second paths other than the first path based on the interference power, and
to determine whether the received signal is received in a one-path state including only the first path, or in a multi-path state including the first and second paths, based on the power value of the first path and the power values of the second paths.

2. The wireless communication apparatus as claimed in claim 1, wherein the signal processing unit determines whether the received signal is received in the one-path state or the multi-path state based on a ratio of the power value of the first path to the power values of the second paths.

3. The wireless communication apparatus as claimed in claim 1, wherein the interference power is calculated in terms of a ratio of the interference power to the power value of the first path, and
the signal processing unit changes the ratio based on a timing difference between a detection timing of the first path and detection timings of the second paths.

4. The wireless communication apparatus as claimed in claim 1, wherein the signal processing unit obtains the interference power of the second paths based on the ratio, and calculates the power values of the second paths based on the interference power of the second paths.

5. The wireless communication apparatus as claimed in claim 1, wherein if the one or more second paths include a plurality of paths, the signal processing unit calculates the power values for predetermined paths in the plurality of paths.

6. A one-path state determination method comprising:
receiving a radio signal,
detecting a phase shift between a detection timing of a path relevant to the received signal at the wireless unit and a path timing of the received signal,
calculating interference power by a first path having a maximum power value based on the phase shift,
calculating power of one or more second paths other than the first path based on the interference power, and
determining whether the received signal is received in a one-path state including only the first path, or in a multi-path state including the first and second paths, based on the power value of the first path and the power values of the second paths.

7. The one-path state determination method as claimed in claim 6, wherein the determining determines whether the received signal is received in the one-path state or the multi-path state based on a ratio of the power value of the first path to the power values of the second paths.

8. The one-path state determination method as claimed in claim 6, wherein the interference power is calculated in terms of a ratio of the interference power to the power value of the first path, and
the ratio is changed based on a timing difference between a detection timing of the first path and detection timings of the second paths.

9. The one-path state determination method as claimed in claim 8, wherein the interference power of the second paths is obtained based on the ratio, and the power values of the second paths are calculated based on the interference power of the second paths.

10. The one-path state determination method as claimed in claim 6, wherein if the one or more second paths include a plurality of paths, the power values of the second paths are calculated for predetermined paths in the plurality of paths.

11. A signal processing circuit comprising:
a signal processing unit configured
to detect a phase shift between a detection timing of a path relevant to a received signal at a wireless unit and a path timing of the received signal,
to calculate interference power by a first path having a maximum power value based on the phase shift,
to calculate power of one or more second paths other than the first path based on the interference power, and
to determine whether the received signal is received in a one-path state including only the first path, or in a multi-path state including the first and second paths, based on the power value of the first path and the power values of the second paths.
